(19) United States
(12) Patent Application Publication
(10) Pub. No.: US 2025/0366533 A1
(43) Pub. Date: Dec. 4, 2025

(54) AEROSOL GENERATING DEVICE

(71) Applicant: SHENZHEN MERIT TECHNOLOGY CO., LTD., Shenzhen (CN)

(72) Inventors: Yubo GUO, Shenzhen (CN); Zutao JIN, Shenzhen (CN); Feng LIANG, Shenzhen (CN)

(73) Assignee: SHENZHEN MERIT TECHNOLOGY CO., LTD., Shenzhen (CN)

(21) Appl. No.: 19/305,880

(22) Filed: Aug. 21, 2025

Related U.S. Application Data
(63) Continuation of application No. PCT/CN2023/134704, filed on Nov. 28, 2023.

(30) Foreign Application Priority Data
Feb. 21, 2023 (CN) 202320328843.9

(51) Int. Cl. A24F 40/60; A24F 40/20; A24F 40/57; H05B 3/20

(52) U.S. Cl. CPC A24F 40/60; A24F 40/57; H05B 3/20; A24F 40/20

(57) ABSTRACT

An aerosol generating device includes a main body, a movable assembly, and a controller. The main body is provided with a cavity and a hole. The cavity is communicated with the outside through the hole, and the cavity is configured to accommodate an aerosol generating substrate. The movable assembly is mounted on the main body and is switchable between a first position and a second position.

### RELATED APPLICATIONS

The present application is a continuation of International Patent Application No. PCT/CN2023/134704, filed on Nov. 28, 2023, which claims priority to Chinese Patent Application No. 202320328843.9, filed on Feb. 21, 2023. The entire disclosure of the prior applications are hereby incorporated by reference.

### TECHNICAL FIELD

This disclosure relates to the technical field of atomization, including to an aerosol generating device.

### BACKGROUND

The aerosol generating device is a small-sized device that can act on an aerosol generating substrate and generate an aerosol by using a Heat Not Burning (HNB) technology. Specifically, the aerosol generating device usually heats the aerosol generating substrate to a temperature at which the aerosol can be generated but the aerosol generating substrate cannot burn, so that the aerosol generating substrate can generate the aerosol for a user to puff without burning.

Currently, to keep the interior of the main body of the aerosol generating device clean and prevent an external substance from falling into the main body, the aerosol generating device is usually provided with a cover body, and the cover body is configured to cover or open a hole that is provided in the main body and is configured to accommodate the aerosol generating substrate. In addition, the aerosol generating device may further be provided with a control switch, and the control switch is configured to trigger another component located in the main body to start to work. The control switch is usually arranged on the main body, which occupies space on main body, and is not beneficial to miniaturization of the aerosol generating device.

### SUMMARY

This disclosure provides an aerosol generating device, at least for solving a problem of how to achieve miniaturization of the aerosol generating device.

The aerosol generating device includes a main body, a movable assembly, and a controller. The main body is provided with a cavity and a hole, the cavity is communicated with the outside through the hole, and the cavity is configured to accommodate an aerosol generating substrate. The movable assembly is mounted on the main body and is switchable between a first position and a second position relative to the main body. The hole is covered when the movable assembly is located at the first position, and the hole is opened when the movable assembly is located at the second position. The movable assembly is integrated with a control switch, and the control switch is configured to generate a trigger signal when triggered. The trigger signal is received by a controller located in the main body.

In some examples, the control switch is triggered to generate a first trigger signal when the movable assembly is located at the first position of the main body; the control switch is triggered to generate a second trigger signal when the movable assembly is located at the second position of the main body; and the controller is configured to perform different functions according to the first trigger signal and the second trigger signal.

In some examples, the movable assembly is mounted at the top of the main body and is slidable along the top of the main body to reach the first position of the main body or the second position of the main body.

In some examples, the movable assembly is at least partially accommodated in the top of the main body. In some examples, the top of the main body is at least partially accommodated in the movable assembly.

In some examples, the movable assembly is detachably mounted at a plurality of positions at the top of the main body, where the plurality of positions include the first position of the main body and the second position of the main body.

In some examples, the movable assembly includes a carrier, a control component, and the control switch, where the carrier and the control component are combined with each other to form an accommodating cavity together, the control switch is accommodated in the accommodating cavity, the control component is exposed to the outside of the main body, the carrier and/or the control component is in contact with the top of the main body, and the control component triggers the control switch when the control component is operated.

In some examples, the carrier and the control component are of an integrated structure. In some examples, the carrier and the control component are of split structures.

In some examples, the control switch includes a circuit board and a trigger component, the circuit board includes a first side and a second side that are opposite to each other, and the first side is closer to the interior of the main body than the second side; and the circuit board is mounted on the control component, the trigger component is located on the first side, and the trigger component is relatively spaced from or in relative contact with the bottom wall of the carrier.

In some examples, the control switch includes a circuit board and a trigger component, the circuit board includes a first side and a second side that are opposite to each other, and the first side is closer to the interior of the main body than the second side; and the circuit board is mounted on the carrier, the trigger component is located on the second side, and the trigger component is relatively spaced from or in relative contact with the top wall of the control component.

In some examples, the control switch includes a circuit board and a trigger component, the circuit board includes a first side and a second side that are opposite to each other, and the first side is closer to the interior of the main body than the second side; and the circuit board is mounted on the control component, the trigger component is located on the first side, and the trigger component is relatively spaced from or in relative contact with the bottom wall of the carrier.

In some examples, the control switch includes a circuit board and a trigger component, the circuit board includes a first side and a second side that are opposite to each other, and the first side is closer to the interior of the main body than the second side; and the circuit board is mounted on the control component, the trigger component is located on the second side, and the trigger component is relatively spaced from or in relative contact with the bottom wall of the control component.

In some examples, the bottom wall of the carrier is provided with a through hole; and the electrical connector includes an elastic pin connector, the pin connector is mounted on the main body, and a pin of the pin connector extends into the accommodating cavity from the through hole and is electrically connected to the circuit board.

In some examples, the bottom wall of the carrier is provided with a through hole; and the electrical connector includes a flexible circuit board or a wire, one end of the flexible circuit board or the wire is accommodated in the main body, and the other end extends into the accommodating cavity from the through hole and is electrically connected to the circuit board.

In some examples, the bottom wall of the carrier is provided with a through hole; and the electrical connector includes a conductive elastic plate, one end of the conductive elastic plate is located in the main body, and the other end extends into the accommodating cavity from the through hole and is electrically connected to the circuit board. According to the aerosol generating device of the examples of this disclosure, the control switch is integrated to the movable assembly, and a trigger signal generated by the control switch is transmitted to the controller in the main body through the electrical connector, so as to control a working state of the aerosol generating device. A control switch does not need to be arranged on the main body, to avoid occupying space on the main body, thereby facilitating miniaturization of the aerosol generating device.

Additional aspects and advantages of this disclosure will be given in the following description, some of which will become apparent from the following description of this disclosure.

### BRIEF DESCRIPTION OF THE DRAWINGS

The above and/or additional aspects and advantages of this disclosure will become apparent and readily understood from the description of examples with reference to accompanying drawings.

FIG. 1 is a schematic diagram of three-dimensional assembly of an aerosol generating device according to this disclosure;

FIG. 2 is a schematic diagram of three-dimensional decomposition of an aerosol generating device according to this disclosure;

FIG. 3 is a schematic cross-sectional view of the aerosol generating device shown in FIG. 2;

FIG. 4 is an enlarged schematic diagram of a position IV of the aerosol generating device shown in FIG. 3;

FIG. 5 is a schematic diagram of three-dimensional decomposition of an aerosol generating device according to this disclosure;

FIG. 6 is a schematic cross-sectional view of the aerosol generating device shown in FIG. 5;

FIG. 7 is an enlarged schematic diagram of a position VII of the aerosol generating device shown in FIG. 6; and

FIG. 8 is a schematic diagram of three-dimensional decomposition of an aerosol generating device according to this disclosure.

### DETAILED DESCRIPTION

To make above objects, features, and advantages of this disclosure more apparent and comprehensible, specific examples of this disclosure are described in detail with reference to accompanying drawings. Many specific details are described in the following description to facilitate a full understanding of this disclosure. However, this disclosure can be implemented in many other ways different from those described herein. Those skilled in the art can make similar improvements without departing from the connotation of the disclosure. Thus, this disclosure is not limited by specific examples disclosed below.

In the description of this application, it is to be understood that orientations or positional relationships indicated by terms such as “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “anticlockwise”, “axial direction”, “radial direction”, and “circumferential direction” are based on orientations or positional relationships shown in the accompanying drawings, and are merely for the convenience of describing this application and simplifying the descriptions, rather than indicating or implying that mentioned apparatus or component has to have a particular orientation or has to be constructed and operated in a particular orientation.

In addition, terms “first” and “second” are used merely for the purpose of description, and cannot be construed as indicating or implying relative importance or implying a quantity of indicated technical features. Therefore, a feature restricted by “first” or “second” may explicitly indicate or implicitly include at least one of such features. In description of this application, “a plurality of” means at least two.

In this disclosure, unless otherwise explicitly specified or defined, terms such as “mount”, “interconnect”, “connect”, and “fix” are to be understood in a broad sense. For example, a connection may be a fixed connection, a detachable connection, or an integral connection; or the connection may be a mechanical connection or an electrical connection; or the connection may be a direct connection, an indirect connection through an intermediary, or internal communication between two elements or mutual action relationship between two elements, unless otherwise specified explicitly. A person of ordinary skill in the art may understand specific meanings of the foregoing terms in this disclosure according to specific situations.

In this disclosure, unless otherwise explicitly specified or defined, a first feature being located “above” or “below” a second feature may be that the first feature is in direct contact with the second feature, or the first feature is in indirect contact with the second feature through an intermediate medium. In addition, the first feature being “above”, “over”, or “on” the second feature may be that first feature is directly above or obliquely above the second feature, or may merely be that the horizontal position of the first feature is higher than that of the second feature. The first feature being “below”, “under”, and “beneath” the second feature may be that the first feature is right below the second feature or at an inclined bottom of the second feature, or may merely be that the horizontal position of the first feature is lower than that of the second feature.

It is to be noted that, when referred to as “being fixed to” or “being arranged at” another element, an element may be directly on another element, or an intermediate element may exist. When considered as “being connected to” another element, an element may be directly connected to another element, or an intermediate element may exist. Terms such as “perpendicular”, “horizontal”, “upper”, “lower”, “left”, “right”, and similar expressions used herein are merely for the purpose of description, but do not indicate a unique example.

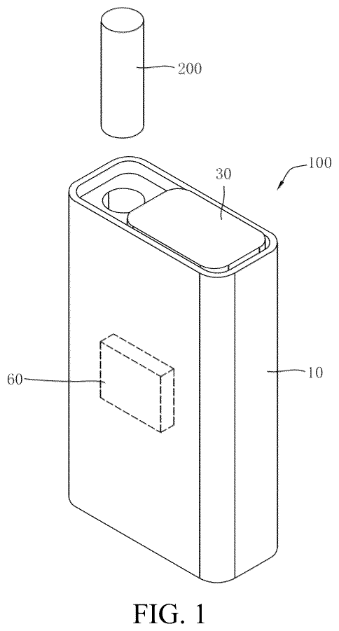

To keep the interior of the main body of the aerosol generating device clean and prevent an external substance from falling into the main body, the aerosol generating device is usually provided with a cover body, and the cover body is configured to cover or open a hole that is provided in the main body and is configured to accommodate the aerosol generating substrate. In addition, the aerosol generating device may further be provided with a control switch, and the control switch is configured to trigger another component located in the main body to start to work. The control switch is usually arranged on the main body, which occupies space on main body, and is not beneficial to miniaturization of the aerosol generating device. To solve this problem, examples of this disclosure provide an aerosol generating device 100 (shown in FIG. 1).

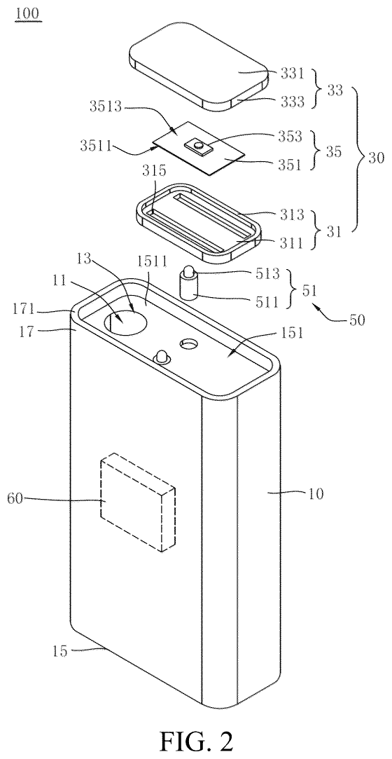

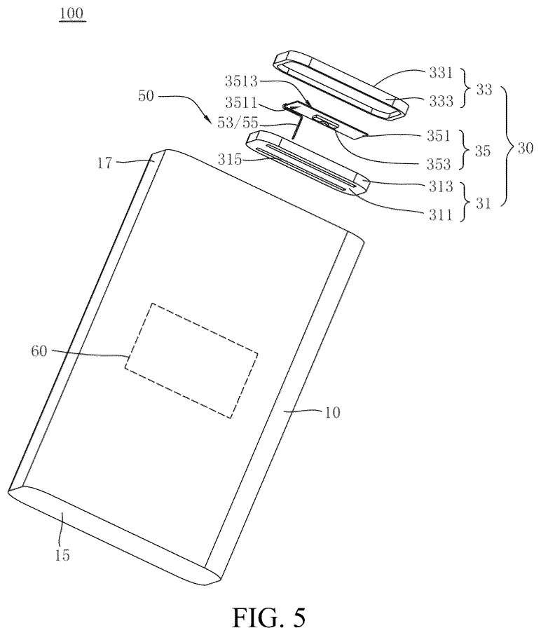

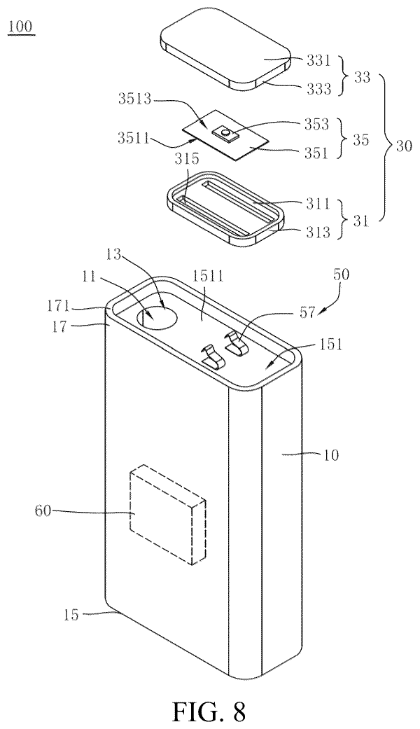

Referring to FIG. 1, FIG. 2, FIG. 5, and FIG. 8, the aerosol generating device 100 according to the examples of this disclosure includes a main body 10, a movable assembly 30, and an electrical connector 50. The main body 10 is provided with a cavity 11 and a hole 13. The cavity 11 is communicated with the outside through the hole 13, and the cavity 11 is configured to accommodate an aerosol generating substrate 200. The movable assembly 30 is mounted on the main body 10 and is switchable between a first position relative to the main body 10 and a second position relative to the main body 10. The hole 13 is covered when the movable assembly 30 is located at the first position, and the hole 13 is opened when the movable assembly 30 is located at the second position. The movable assembly 30 is integrated with a control switch 35, and the control switch 35 is configured to generate a trigger signal when triggered. The electrical connector 50 is electrically connected to both the control switch 35 and a controller 60 located in the main body 10 when the movable assembly 30 is located at the first position of the main body 10 or the second position of the main body 10, and the electrical connector 50 is configured to transmit the trigger signal to the controller 60.

The aerosol generating device 100 is a structure that can act on the aerosol generating substrate 200 through resistive heating, electromagnetic heating, microwave heating, laser radiation, infrared light radiation, ultrasonic or mechanical oscillation, and the like to generate an aerosol. For example: the aerosol generating device 100 heats the aerosol generating substrate 200 by using infrared light radiation to generate an aerosol. The aerosol may be visible or invisible and may include vapor (for example, fine particulate matter in a gaseous state, which is usually liquid or solid at room temperature) and liquid droplets of gas and concentrated vapor. The “aerosol” herein includes an aerosol generated by heating the aerosol generating substrate 200 in a heated aerosol generating product and an aerosol generated when the aerosol generating substrate 200 in a combustible smoking product is burnt.

The aerosol generating substrate 200 is a plant leaf product that is processed and that can generate an aerosol after being heated. The form of the aerosol generating substrate 200 may be an all-solid state or a semi-solid state. The aerosol generating substrate 200 may be prepared by using a process such as rolling, pasting, casting, and extruding when the aerosol generating substrate 200 is in the all-solid state. The aerosol generating substrate 200 may be a cylindrical structure similar to a cigarette, or may be a sheet-like structure, a strip-like structure, or a block-like structure. In this disclosure, the aerosol generating substrate 200 is described by using a cylindrical structure shown in FIG. 1 as an example.

According to the aerosol generating device 100 in this example of this disclosure, the control switch 35 is integrated into the movable assembly 30, and the trigger signal generated by the control switch 35 is transmitted to the controller 60 in the main body 10 by using the electrical connector 50, so that the controller 60 can control, according to the trigger signal, another component located in the main body 10. The control switch 35 does not need to be arranged on the main body 10, to avoid occupying space on the main body 10, thereby facilitating miniaturization of the aerosol generating device 100. Other components include, but is not limited to, a battery, a heater, a prompter, and the like. For example, the controller 60 can control, according to the trigger signal, the battery to start supplying power, stop supplying power, and control supply power of the battery. The controller 60 can further control, according to the trigger signal, the heater to start heating, stop heating, and control a heating mode of the heater. The controller 60 can further control, according to the trigger signal, the prompter to prompt the number of puffs of the aerosol generating device 100, prompt the remaining number of puffs of the aerosol generating device 100, prompt battery level, and the like.

The control switch 35 is triggered to generate a first trigger signal when the movable assembly 30 is located at the first position of the main body 10. The control switch 35 is triggered to generate a second trigger signal when the movable assembly 30 is located at the second position of the main body 10. The controller 60 is configured to perform different functions according to the first trigger signal and the second trigger signal. For example, the controller 60 is configured to: control, according to the first trigger signal, the battery to start supplying power, and control, according to the second trigger signal, the battery to stop supplying power. For another example, the controller 60 is configured to: control, according to the first trigger signal, the heater to start heating, and control, according to the second trigger signal, the battery to stop supplying power. For another example, the controller 60 is configured to control, according to the first trigger signal, the prompter to prompt the battery level. The controller 60 is configured to control, according to the second trigger signal, the heater to start heating, so that the control switch 35 is triggered to generate the first trigger signal when the movable assembly 30 is at the first position, that is, when the hole 13 is covered by the movable assembly 30, and the movable assembly 30 is operated (for example, pressed once), the controller 60 controls, according to the first trigger signal, the prompter to prompt the battery level, and a user may determine, according to the prompt, whether the battery level can meet a puffing requirement. If the puffing requirement is met, the movable assembly 30 may be changed to the second position, that is, the hole 13 is opened by the movable assembly 30, and the user may place the aerosol generating substrate 200 from the hole 13 into the cavity 11. In this case, if the movable assembly 30 is operated again (for example, pressed twice), the control switch 35 is triggered again to generate the second trigger signal, and the controller 60 controls, according to the second trigger signal, the heater to start heating, so that the aerosol generating substrate 200 generates an aerosol for the user to puff.

In addition, when a conventional aerosol generating device is configured to puff, a cover body needs to be opened first to load the aerosol generating substrate from a hole into a main body, and then a finger moves to a control switch on the main body for triggering, so as to control another component on the aerosol generating device to work. A process of controlling other component needs to be implemented only by operating two different components, for example, operating the cover body outside the main body and the control switch on the main body, and an entire operation process is complex. According to the aerosol generating device 100 in this disclosure, the control switch 35 is integrated into the movable assembly 30, and the movable assembly 30 is designed to be slidable between the first position relative to the main body 10 and the second position relative to the main body 10. In this way, a process of controlling another component includes: the movable assembly 30 is operated to be located at the second position to open the hole 13, so that the aerosol generating substrate 200 can be loaded into the main body 10 from the hole 13, then the movable assembly 30 is operated again to trigger the control switch 35 to generate a trigger signal. After the trigger signal is transmitted to the controller 60 through the electrical connector 50, the controller 60 can control, according to the trigger signal, another component located in the main body 10 to start working. By comparison, the entire control process is performed for the same component, that is, the movable assembly 30, so that the entire control process is simple and user experience is good.

The aerosol generating device 100 is further described below with reference to the accompanying drawings.

Referring to FIG. 2, FIG. 5, and FIG. 8, the main body 10 is of a roughly cylindrical structure, and components such as a battery (not shown in the figures), the controller 60, a heating element (not shown in the figures), and a heater (not shown in the figures) may be mounted in the main body 10. The cross-sectional shape of the outer contour of the main body 10 includes, but is not limited to, a circle, an ellipse, a rectangle, a triangle, a regular polygon, another non-regular polygon, and the like. This disclosure describes only by using an example in which the main body 10 is of a cuboid structure, that is, the cross-sectional shape of the outer contour of the main body 10 is a rectangle. In some examples, the main body 10 may be made of a material having good heat conducting performance, for example, be made of a metal or an alloy material such as copper or aluminum, so that heat from elements inside the main body 10 can be quickly radiated, and the texture of the entire aerosol generating device 100 can be improved. In some other examples, the main body 10 may be made of another material that can conduct heat. For example, the main body 10 is made of a material such as ceramics or high-heat-conductivity plastic.

Specifically, the main body 10 includes a bottom 15 and a top 17 that are opposite to each other. In an example, the bottom 15 of the main body 10 is closed, so that the main body 10 provides a loading space that is closed at one end for elements mounted inside the main body 10, thereby providing protection such as waterproofing, anti-dirt, and anti-collision for these elements, thereby prolonging the service life of the aerosol generating device 100. In another example, some functional openings may be provided in the bottom 15 of the main body 10. For example, an air inlet, a charging interface, and a data card socket are provided. On one hand, the bottom 15 of the main body 10 can still provide protection such as waterproofing, anti-dirt, and anti-collision for elements inside the main body 10. On the other hand, the functional openings are provided in the bottom 15 of the main body 10, which extends functions of the aerosol generating device 100, for example, a charging function and a storage function, and meets current market requirements for a plurality of functions of the aerosol generating device 100.

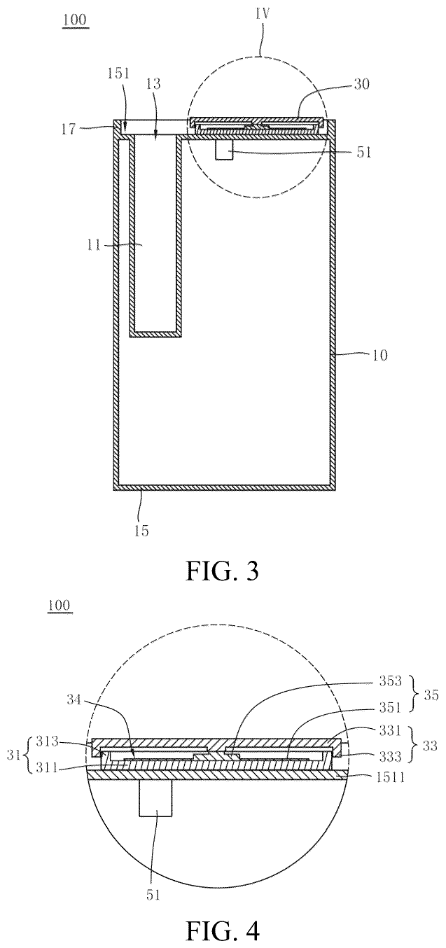

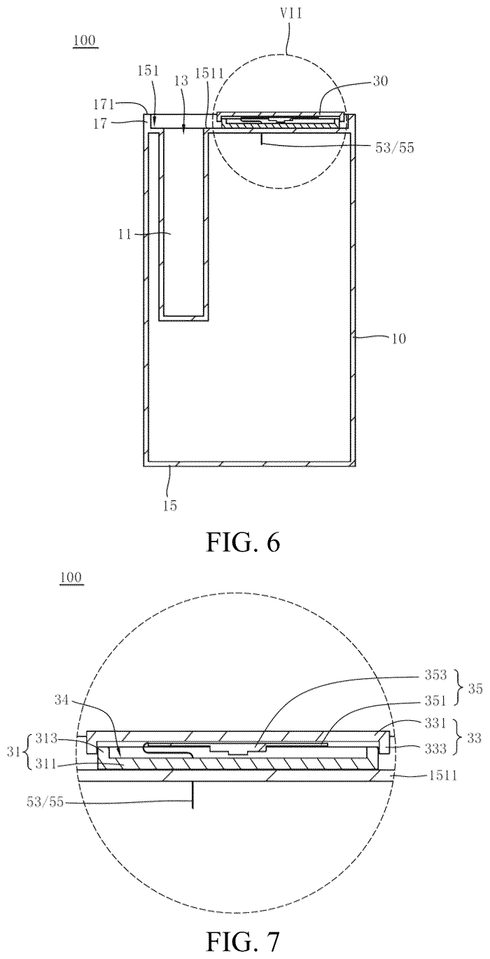

Referring to FIG. 2, FIG. 3, FIG. 6, and FIG. 8, the hole 13 is provided in the top 17 of the main body 10, the cavity 11 is arranged inside the main body 10, and the cavity 11 is communicated with the outside through the hole 13. Specifically, in an example, the top 17 of the main body 10 is provided with a groove 151, and the bottom 1511 of the groove 151 is provided with the hole 13. The groove 151 may be configured to accommodate least a part of structure of the movable assembly 30. In this way, the overall height of the aerosol generating device 100 may be reduced. In another example, the top 17 of the main body 10 is not provided with the groove 151 shown in FIG. 3, FIG. 6, and FIG. 8. In this case, the top 17 of the main body 10 includes a top surface that covers an internal structure of the main body 10, and the hole 13 is provided in the top surface of the main body 10.

With reference to FIG. 1, the cavity 11 is arranged inside the main body 10, and is configured to accommodate an aerosol generating substrate 200. The cavity 11 is communicated with the hole 13, so that a user can place the aerosol generating substrate 200 into the cavity 11 through the hole 13. The structural form of the cavity 11 is adapted to the structural form of the aerosol generating substrate 200, so as to limit the aerosol generating substrate 200. For example, when the aerosol generating substrate 200 is of a cylindrical structure, the cavity 11 is cylindrical. For example, the cross section of the cavity 11 is a circle. When the aerosol generating substrate 200 is of a rectangular sheet-like structure, the cavity 11 is cuboid, for example, the cross section of the cavity 11 is a rectangle. For another example, after the aerosol generating substrate 200 is loaded into the cavity 11, the aerosol generating substrate 200 and the inner wall of the cavity 11 may be pressed against each other, or a gap remains.

Referring to FIG. 2, FIG. 5, and FIG. 8, in some examples, the movable assembly 30 is mounted at the top 17 of the main body 10 and is slidable along the top 17 of the main body 10 to reach the first position of the main body 10 or the second position of the main body 10. The first position may be a first region scope covering a plurality of position points on the main body 10, or may be a specific first position point on the main body 10. When the movable assembly 30 is located within the first region scope or at the specific first position point, the hole 13 is covered by the movable assembly 30.

Similarly, the second position may alternatively be a second region scope covering a plurality of position points on the main body 10, or may be a specific second position point on the main body 10. When the movable assembly 30 is located within the second region scope or at the specific second position, the movable assembly 30 opens the hole 13, that is, the movable assembly 30 uncovers the entire hole 13. “Covering” includes complete cover, or may include partial cover, provided that the cavity 11 can be closed to some extent. “Open” includes completely open, or may include partially open, provided that a user can place the aerosol generating substrate 200 into the cavity 11 through the hole 13. It may be learned that opening degree or covering degree of the hole 13 is not limited, and may be determined by the user.

In another example, the movable assembly 30 may alternatively rotate relative to the main body 10 to switch between the first position and the second position, or the movable assembly 30 may rotate and slide relative to the main body 10 to switch between the first position and the second position. This is not limited herein.

Specifically, in some examples, the movable assembly 30 is at least partially accommodated in the top 17 of the main body 10. In this case, still referring to FIG. 2, FIG. 5, and FIG. 8, the top 17 of the main body 10 is provided with the groove 151, the bottom 1511 of the groove 151 is provided with the hole 13, and the movable assembly 30 is at least partially accommodated in the groove 151. In an example, the movable assembly 30 is completely accommodated in the groove 151. In another example, a part of structure of the movable assembly 30 is accommodated in the groove 151, and another part extends out of the groove 151 and protrudes relative to a top surface 171. Regardless of whether the movable assembly 30 is completely accommodated in the groove 151 or partially accommodated in the groove 151, the arrangement of the groove 151 can reduce the overall height of the aerosol generating device 100. In addition, if the size of the groove 151 is adapted to the size of the movable assembly 30, the groove 151 can play a guiding role in a sliding process of the movable assembly 30, so that the movable assembly 30 can stably slide in the groove 151, thereby preventing the movable assembly 30 from being stuck due to sliding offset. Certainly, in another example, a first guide component may be provided on the inner wall of the groove 151. Correspondingly, a second guide component may be provided on the movable assembly 30. The second guide cooperates with the second guide, which may alternatively play a guiding role in a sliding process of the movable assembly 30.

In some other examples, the top 17 of the main body 10 is at least partially accommodated in the movable assembly 30. In other words, the movable assembly 30 is sleeved over the top 17 of the main body 10. In an example, the top 17 of the main body 10 may still be provided with the groove 151, and the hole 13 is provided in the bottom 1511 of the groove 151. In this case, a first part of structure of the movable assembly 30 is accommodated in the groove 151, a second part of structure of the movable assembly 30 extends out of the groove 151 and covers the top 17 of the main body 10. There is a gap between the first part of structure and the second part of structure. Two opposite side walls of the top 17 of the main body 10 extend into the gap, to guide the movable assembly 30 to slide along the top 17 of the main body 10.

In another example, the top 17 of the main body 10 may not be provided with the groove 151, and the hole 13 is provided in the top surface 171 of the main body 10. In this case, the first part of structure of the movable assembly 30 is similar to the structure of a bottle cap, and the opposite two sides of the first part of structure are directly sleeved over the opposite side walls of the top 17 of the main body 10, to guide the movable assembly 30 to stably slide along the top 17 of the main body 10. The second part of structure of the movable assembly 30 is located on one side of the first part of structure that faces away from the top surface 171 of the main body 10, that is, the second part of structure of the movable assembly 30 protrudes relative to the first part of structure. In a sliding process of the movable assembly 30, the second part of structure can be gripped by a user, thereby facilitating pushing the movable assembly 30 to slide.

In some other examples, the movable assembly 30 can be detachably mounted at a plurality of positions on the top 17 of the main body 10, where the plurality of positions include the first position of the main body 10 and the second position of the main body 10. Explanations of the “first position” and the “second position” herein are the same as those the previous text, and details are not described herein again. Manners in which the movable assembly 30 can be detachably mounted to the top 17 of the main body 10 include but are not limited to: clamping, screwing, a combination thereof, or the like. When the movable assembly 30 is initially located at the first position to cover the hole 13, if the hole 13 needs to be opened for accommodating the aerosol generating substrate 200 (shown in FIG. 1), a user may first disassemble the movable assembly 30 from the first position of the main body 10 and then mount the movable assembly 30 to the second position of the main body 10. Similarly, when the movable assembly 30 is initially located at the second position to open the hole 13, if the aerosol generating substrate 200 (shown in FIG. 1) is loaded and the hole 13 needs to be covered to perform puffing, the user may first disassemble the movable assembly 30 from the second position of the main body 10 and then mount the movable assembly 30 to the first position of the main body 10. Specifically, referring to FIG. 2, FIG. 5, and FIG. 8, in some examples, the movable assembly 30 includes a carrier 31, a control component 33, and a control switch 35. With reference to FIG. 4 and FIG. 7, the carrier 31 and the control component 33 are combined with each other to form an accommodating cavity 34 together, and the control switch 35 is accommodated in the accommodating cavity 34. The control component 33 is exposed to the outside of the main body 10. The carrier 31 and/or the control component 33 is in contact with the top 17 of the main body 10. When the control component 33 is operated, the control component 33 triggers the control switch 35. An “operation” of the user includes, but is not limited to, manners such as pressing (including pressing once, pressing for a plurality of times, and the like), touching, and moving towards two sides again at the first position or the second position.

In some examples, the carrier 31 and the control component 33 are of an integrated structure. In this way, the carrier 31 and the control component 33 are firmly combined, the carrier 31 and the control component 33 are not easily separated, and the movable assembly 30 slides along the top 17 of the main body 10 more stably. In an aspect, the carrier 31 and the control component 33 are of split structures, and the carrier 31 and the control component 33 may be combined with each other in a detachable or non-detachable connection manner to form the accommodating cavity 34. When the carrier 31 is detachably connected to the control component 33, the control switch 35 convenient to open for replacement when damaged. When the carrier 31 is in a non-detachable connection with the control component 33, it can be ensured that the carrier 31 and the control component 33 are firmly combined, the carrier 31 and the control component 33 are not easily separated, and the movable assembly 30 slides along the top 17 of the main body 10 more stably.

More specifically, referring to FIG. 2, FIG. 5, and FIG. 8, the bottom wall 311 of the carrier 31 is provided with a through hole 315, the through hole 315 penetrates through the bottom wall 311 of the carrier 31, and the through hole 315 is configured for the electrical connector 50 to pass through. With reference to FIG. 4 and FIG. 7, when the carrier 31 and the control component 33 are of split structures, and the control component 33 is combined with the carrier 31, the control component 33 may be sleeved over the side wall 313 of the carrier 31 to form the accommodating cavity 34, or the carrier 31 may be sleeved over the side wall 333 of the control component 33 to form the accommodating cavity 34.

Referring to FIG. 2, FIG. 5, and FIG. 8, the control switch 35 includes a circuit board 351 and a trigger component 353 arranged on the circuit board 351.

The circuit board 351 may be any one of a rigid circuit board, a flexible circuit board, and a flexible and rigid combined circuit board. The circuit board 351 includes a first side 3511 and a second side 3513 that are opposite to each other, and the first side 3511 is closer to the interior of the main body 10 than the second side 3513.

In an example, the circuit board 351 is mounted on the carrier 31, as shown in FIG. 4.

In an example, referring to FIG. 3 and FIG. 4, the circuit board 351 is carried on the bottom wall 311 of the carrier 31, and the trigger component 353 is located on the second side 3513 of the circuit board 351 and is opposite to the top wall 331 of the control component 33. In this case, the trigger component 353 may be spaced from the top wall 331 of the control component 33, or the trigger component 353 may be in contact with the top wall 331 of the control component 33 but no force is generated between the trigger component 353 and the top wall 331 of the control component 33. When the control component 33 is operated (for example, pressed), the top wall 331 of the control component 33 deforms to some extent, and transfers a force to the trigger component 353. The trigger component 353 is triggered to generate a trigger signal after being stressed. The trigger component 353 is spaced from the top wall 331 of the control component 33, so that a pressing force applied to the control component 33 needs to be relatively large to trigger the trigger component 353, which can prevent the finger of the user from pressing the control component 33 by mistake to trigger the trigger component 353 by mistake during sliding of the movable assembly 30. However, the trigger component 353 is in contact with the top wall 331 of the control component 33 but no force is generated between the trigger component 353 and the top wall 331 of the control component 33, so that the trigger component 353 can be triggered by using a relatively small pressing force after a sliding operation is completed, thereby improving a generation rate of the trigger signal, and further improving control sensitivity of the controller 60 (shown in FIG. 2).

In another example, the circuit board 351 is spaced from the bottom wall 311 of the carrier 31, the circuit board 351 may be combined with the side wall 313 of the carrier 31, and the trigger component 353 is located on the first side 3511 of the circuit board 351 and is opposite to the bottom wall 311 of the carrier 31. In this case, the trigger component 353 is spaced from the bottom wall 311 of the carrier 31, or the trigger component 353 is in contact with the bottom wall 311 of the carrier 31 but no force is generated between the trigger component 353 and the bottom wall 311 of the carrier 31. When the control component 33 is operated (for example, pressed), the control component 33 deforms to some extent, and transfers a force to the circuit board 351. After being stressed, the circuit board 351 drives the trigger component 353 to move toward the bottom wall 311 of the carrier 31 until the trigger component 353 is in contact with the bottom wall 311 of the carrier 31 and is triggered after being stressed, thereby generating a trigger signal. The trigger component 353 is spaced from the bottom wall 311 of the carrier 31, so that a pressing force applied to the control component 33 needs to be relatively large to trigger the trigger component 353, which can prevent the finger of the user from pressing the control component 33 by mistake to trigger the trigger component 353 by mistake during sliding of the movable assembly 30. However, the trigger component 353 is in contact with the bottom wall 311 of the carrier 31 but no force is generated between the trigger component 353 and the bottom wall 331 of the carrier 31, so that the trigger component 353 can be triggered by using a relatively small pressing force after a sliding operation is completed, thereby improving a generation rate of the trigger signal, and further improving control sensitivity of the controller 60 (shown in FIG. 2).

In still another example, the circuit board 351 is spaced from the bottom wall 311 of the carrier 31, the circuit board 351 may be combined with the side wall 313 of the carrier 31, and the trigger component 353 is located on the second side 3513 of the circuit board 351 and is opposite to the top wall 331 of the control component 33. In this case, the trigger component 353 and the top wall 331 of the control component 33 may be spaced from each other or may be in contact with each other but no force is generated between the trigger component 353 and the top wall 331 of the control component 33. When the control component 33 is operated (for example, pressed), the control component 33 deforms to some extent, and transfers a force to the trigger component 353. The trigger component 353 is triggered to generate a trigger signal after being stressed. The trigger component 353 is spaced from the top wall 331 of the control component 33, so that a pressing force applied to the control component 33 needs to be relatively large to trigger the trigger component 353, which can prevent the finger of the user from pressing the control component 33 by mistake to trigger the trigger component 353 by mistake during sliding of the movable assembly 30. However, the trigger component 353 is in contact with the top wall 331 of the control component 33 but no force is generated between the trigger component 353 and the top wall 331 of the control component 33, so that the trigger component 353 can be triggered by using a relatively small pressing force after a sliding operation is completed, thereby improving a generation rate of the trigger signal, and further improving control sensitivity of the controller 60.

In another example, the circuit board 351 is mounted on the control component 33, as shown in FIG. 7.

Referring to FIG. 5 to FIG. 7, in an example, the circuit board 351 is carried on the top wall 331 of the control component 33, and the trigger component 353 is located on the first side 3511 of the circuit board 351 and is opposite to the bottom wall 311 of the carrier 31. In this case, the trigger component 353 may be spaced from the bottom wall 311 of the carrier 31, or the trigger component 353 may be in contact with the bottom wall 311 of the carrier 31 but no force is generated between the trigger component 353 and the bottom wall 311 of the carrier 31. When the control component 33 is operated (for example, pressed), the control component 33 drives the trigger component 353 to move toward the bottom wall 311 of the carrier 31 together until the trigger component 353 is in contact with the bottom wall 311 of the carrier 31 and is triggered after being stressed, thereby generating a trigger signal. The trigger component 353 is spaced from the bottom wall 311 of the carrier 31, so that a pressing force applied to the control component 33 needs to be relatively large to trigger the trigger component 353, which can prevent the finger of the user from pressing the control component 33 by mistake to trigger the trigger component 353 by mistake during sliding of the movable assembly 30. However, the trigger component 353 is in contact with the bottom wall 311 of the carrier 31 but no force is generated between the trigger component 353 and the bottom wall 331 of the carrier 31, so that the trigger component 353 can be triggered by using a relatively small pressing force after a sliding operation is completed, thereby improving a generation rate of the trigger signal, and further improving control sensitivity of the controller 60.

In another example, the circuit board 351 is spaced from the top wall 331 of the control component 33, the circuit board 351 may be combined with the side wall 333 of the control component 33, and the trigger component 353 is located on the first side 3511 of the circuit board 351 and is opposite to the bottom wall 311 of the carrier 31. In this case, the trigger component 353 is spaced from the bottom wall 311 of the carrier 31, or the trigger component 353 is in contact with the bottom wall 311 of the carrier 31 but no force is generated between the trigger component 353 and the bottom wall 311 of the carrier 31. When the control component 33 is operated (for example, pressed), the top wall 331 of the control component 33 deforms to some extent, and transfers a force to the circuit board 351. After being stressed, the circuit board 351 drives the trigger component 353 to move toward the bottom wall 311 of the carrier 31 until the trigger component 353 is in contact with the bottom wall 311 of the carrier 31 and is triggered after being stressed, thereby generating a trigger signal. The trigger component 353 is spaced from the bottom wall 311 of the carrier 31, so that a pressing force applied to the control component 33 needs to be relatively large to trigger the trigger component 353, which can prevent the finger of the user from pressing the control component 33 by mistake to trigger the trigger component 353 by mistake during sliding of the movable assembly 30. However, the trigger component 353 is in contact with the bottom wall 311 of the carrier 31 but no force is generated between the trigger component 353 and the bottom wall 331 of the carrier 31, so that the trigger component 353 can be triggered by using a relatively small pressing force after a sliding operation is completed, thereby improving a generation rate of the trigger signal, and further improving control sensitivity of the controller 60.

In still another example, the circuit board 351 is spaced from the top wall 331 of the control component 33, the circuit board 351 may be combined with the side wall 333 of the control component 33, and the trigger component 353 is located on the second side 3513 of the circuit board 351 and is opposite to the top wall 331 of the control component 33. In this case, the trigger component 353 and the top wall 331 of the control component 33 may be spaced from each other, or may be in contact with each other but no force is generated between the trigger component 353 and the top wall 331 of the control component 33. When the control component 33 is operated (for example, pressed), the control component 33 deforms to some extent, and transfers a force to the trigger component 353. The trigger component 353 is triggered to generate a trigger signal after being stressed. The trigger component 353 is spaced from the top wall 331 of the control component 33, so that a pressing force applied to the control component 33 needs to be relatively large to trigger the trigger component 353, which can prevent the finger of the user from pressing the control component 33 by mistake to trigger the trigger component 353 by mistake during sliding of the movable assembly 30. However, the trigger component 353 is in contact with the top wall 331 of the control component 33 but no force is generated between the trigger component 353 and the top wall 331 of the control component 33, so that the trigger component 353 can be triggered by using a relatively small pressing force after a sliding operation is completed, thereby improving a generation rate of the trigger signal, and further improving control sensitivity of the controller 60.

Referring to FIG. 2, FIG. 5, and FIG. 8, one end of the electrical connector 50 is located inside the main body 10, and the other end extends into the accommodating cavity 34 from the through hole 315 and is electrically connected to the circuit board 351.

The electrical connector 50 is arranged corresponding to the through hole 315, including: the quantity of the electrical connectors 50 corresponds to the quantity of the through holes 315, and the positions of the electrical connectors 50 correspond to the positions of the through holes 315. In an example, as shown in FIG. 2, FIG. 5, and FIG. 8, if the movable assembly 30 can slide along the top 17 of the main body 10 to reach the first position of the main body 10 or the second position of the main body 10, there are two through holes 315, and there are two electrical connectors 50. An extension direction of each through hole 315 is a sliding direction of the movable assembly 30. In this way, when the movable assembly 30 slides from the first position to the second position, the electrical connector 50 can slide in the through hole 315, so as to ensure that the electrical connector 50 maintains an electrical connection to the circuit board 351 all the time in an entire sliding process of the movable assembly 30.

In another example, when the movable assembly 30 is detachably mounted at the first position of the main body 10 and the second position of the main body 10 as described above, two through holes 315 form a group, and the main body 10 is provided with two groups of through holes 315, which are respectively a first group of through holes 315 and a second group of through holes 315. Correspondingly, two electrical connectors 50 form a group, and there are two groups of electrical connectors 50, which are respectively a first group of electrical connectors 50 and a second group of electrical connectors 50. Each group of electrical connectors 50 is arranged in a corresponding group of through holes 315. When the movable assembly 30 is located at the first position, the first group of electrical connectors 50 penetrate through the first group of through holes 315 to be electrically connected to the circuit board 351, and the second group of electrical connectors 50 penetrate through the second group of through holes 315 but are not electrically connected to the circuit board 351. When the movable assembly 30 is located at the second position, the second group of electrical connectors 50 penetrate through the second group of through holes 315 to be electrically connected to the circuit board 351, and the first group of electrical connectors 50 penetrate through the first group of through holes 315 but are not electrically connected to the circuit board 351. In this way, it can be ensured that the movable assembly 30 can be electrically connected to the electrical connector 50 when the movable assembly 30 is at the first position of the main body 10 or the second position of the main body 10.

Specifically, referring to FIG. 2 and FIG. 4, in some examples, the electrical connector 50 includes an elastic pin connector 51. The pin connector 51 is mounted on the main body 10, and the pin connector 51 includes a body 511 and a pin 513. The body 511 is accommodated in the main body 10, and the pin 513 can be telescopically mounted in the main body 511. The pin 513 of the pin connector 51 extends into the accommodating cavity 34 from the through hole 315 and is electrically connected to the circuit board 351. The circuit board 351 of the movable assembly 30 presses the pin 513, and the pin 513 is subjected to a pushing force from the interior of the body 511 all the time. The pushing force enables the pin 513 to have a tendency to move toward the movable assembly 30, so that regardless of whether the movable assembly 30 is located at the first position or the second position, or slides from the first position to the second position, or slides from the second position to the first position, the circuit board 351 of the movable assembly 30 remains in contact with the pin 513 all the time to implement an electrical connection.

Referring to FIG. 5 to FIG. 7, in another example, the electrical connector 50 includes a flexible circuit board 53 or a wire 55. One end of the flexible circuit board 53 or the wire 55 is accommodated in the main body 10, and the other end extends into the accommodating cavity 34 from the through hole 315 and is electrically connected to the circuit board 351. Because both the flexible circuit board 53 and the wire 55 have flexibility, when the movable assembly 30 is located at the first position or the second position, or slides from the first position to the second position, or slides from the second position to the first position, both the flexible circuit board 53 and the wire 55 can be electrically connected to the controller 60 and the circuit board 351.

Referring to FIG. 8, in still another example, the electrical connector 50 includes a conductive elastic plate 57. One end of the conductive elastic plate 57 is located in the main body 10, and the other end extends into the accommodating cavity 34 from the through hole 315 and is electrically connected to the circuit board 351. The conductive elastic plate 57 may be made of a material that can conduct electricity and has elasticity, for example, may be made of a metal such as copper or stainless steel, or may be made of highly elastic conductive plastic. In an example, the first end of the conductive elastic plate 57 fits the bottom 1511 of the groove 151, and the opposite second end extends into the accommodating cavity 34 from the through hole 315 and is electrically connected to the circuit board 351. An elastic force of the conductive elastic plate 57 enables the second end to have a tendency to move toward the movable assembly 30, so that regardless of whether the movable assembly 30 is located at the first position, the second position, or slides from the first position to the second position, or slides from the second position to the first position, the circuit board 351 in the movable assembly 30 remains in contact with the second end of the conductive elastic plate 57 all the time to implement an electrical connection.

The technical features in the foregoing aspects may be combined. For concise description, not all possible combinations of the technical features in the aspects are described. However, provided that combinations of the technical features do not conflict with each other, the combinations of the technical features are considered as falling within the scope described in this specification. Moreover, other examples can be derived from the above aspects, so that structural and logical replacements and changes can be made without departing from the scope of the disclosure.

The foregoing aspects only describe several examples of this application, which are described specifically and in detail, but cannot be construed as a limitation to the patent scope of this application. It is to be noted that, for a person of ordinary skill in the art, several transformations and improvements can be made without departing from the concept of this application. These transformations and improvements within the protection scope of this disclosure.

What is claimed is:

1. An aerosol generating device comprising:
a main body including a cavity and a hole, the cavity being communicated with the hole, and the cavity being configured to accommodate an aerosol generating substrate;
a movable assembly being mounted on the main body and being switchable between a plurality of positions, the movable assembly including a control switch to generate a trigger signal when triggered; and
a controller, in the main body, receiving the trigger signal.

2. The aerosol generating device according to claim 1, wherein the plurality of positions including a first position and a second position, the hole being covered when the movable assembly is located at the first position, the hole being opened when the movable assembly is located at the second position.

3. The aerosol generating device according to claim 2, further comprising:
the control switch generating a first trigger signal when the movable assembly is located at the first position;
the control switch generating a second trigger signal when the movable assembly is located at the second position; and
the controller performing functions according to the first trigger signal or the second trigger signal.

4. The aerosol generating device according to claim 2, the movable assembly being slidable along the main body to reach the first position or the second position.

5. The aerosol generating device according to claim 4, the movable assembly being at least partially accommodated in the main body; or the main body is at least partially accommodated in the movable assembly.

6. The aerosol generating device according claim 2, the movable assembly further comprising: a carrier, a control component, and the control switch, wherein the carrier and the control component are attached with each other to form an accommodating cavity, the control switch is accommodated in the accommodating cavity, and the carrier and/or the control component is in contact with the top of the main body.

7. The aerosol generating device according to claim 6, the control switch further comprising a circuit board and a trigger component, the circuit board including a first side and a second side that are opposite to each other; and
the circuit board being mounted on the carrier, the trigger component being located on the first side of the circuit board.

8. The aerosol generating device according to claim 6, the control switch further comprising a circuit board and a trigger component, the circuit board including a first side and a second side that are opposite to each other; and
the circuit board being mounted on the carrier, the trigger component being located on the second side of the circuit board.

9. The aerosol generating device according to claim 6, the control switch further comprising a circuit board and a trigger component, the circuit board including a first side and a second side that are opposite to each other; and
the circuit board being mounted on the control component, the trigger component being located on the first side of the circuit board.

10. The aerosol generating device according to claim 6, the control switch further comprising a circuit board and a trigger component, the circuit board including a first side and a second side that are opposite to each other; and
the circuit board being mounted on the control component, the trigger component being located on the second side of the circuit board.

11. The aerosol generating device according to claim 7, further comprising:
a bottom wall of the carrier being provided with a through hole; and
a pin connector being mounted on the main body, and the pin connector being electrically connected to the circuit board.

12. The aerosol generating device according to claim 7, further comprising:
a bottom wall of the carrier being provided with a through hole; and
a flexible conductive material being connected with the main body and the circuit board.

13. The aerosol generating device according to claim 12, wherein the flexible conductive material is a conductive elastic plate.

14. The aerosol generating device according to claim 12, wherein the flexible conductive material at least partially located in the accommodating cavity.

15. The aerosol generating device according to claim 12, wherein the flexible conductive material extending through the through hole.

16. The aerosol generating device according to claim 4, the movable assembly and the hole being located on one side of the main body.

17. The aerosol generating device according to claim 4, the movable assembly and the hole being located on different sides of the main body.
